(19) United States
(12) Patent Application Publication
(10) Pub. No.: US 2016/0231774 A1
(43) Pub. Date: Aug. 11, 2016

(54) DISPLAY MODULE

(71) Applicant: HTC Corporation, Taoyuan City (TW)

(72) Inventors: Chu-Chun Lo, Taoyuan City (TW); Cheng-Min Lin, Taoyuan City (TW); Chih-Lin Chang, Taoyuan City (TW); Jen-Cheng Lai, Taoyuan City (TW)

(21) Appl. No.: 14/614,412

(22) Filed: Feb. 5, 2015

(51) Int. Cl. G06F 1/16; G06F 3/041

(52) U.S. Cl. CPC G06F 1/1626; G06F 3/041

(57) ABSTRACT

A display module including a display panel, an optical film, a cover plate and an optical clear adhesive (OCA) layer is provided. The display panel has a display surface. The optical film is disposed on the display surface, wherein the optical film has a first surface back to the display panel, and the first surface has a plurality of edges and a plurality of corners formed by any adjacent two of the edges crossing each other. The cover plate is disposed on the first surface of the optical film and covers the first surface. The OCA layer is disposed between the cover plate and the optical film and connected with the cover plate and the optical film, wherein the OCA layer covers the edges of the first surface and exposes the corners and a part of regions adjacent to the corners.

### BACKGROUND OF THE INVENTION

1. Field of the Invention

The application relates to a display module, and particularly relates to a display module using an optical clear adhesive layer.

2. Description of Related Art

Recently, with the continuing improvement of science and technology and the progresses of the electronic industry, electronic devices such as notebook (NB) computers, smart phones, and tablet computers are more and more common, and are developed to become more convenient, functional, and artistically designed, so as to offer the user a greater variety of choices. Due to the users' increasing demands on electronic products, display modules, which play an important role in electronic products, have also become the focus of the designers.

The display module may output information in an electronic device in the form of images. A display module usually includes components such as a display panel, a cover plate, and an assembling frame, etc., and may optionally include an optical film or a touch unit based on the needs. In addition, when the display panel is a non-self-emitting display panel, the display module may further include a backlight module, so as to provide light to the display panel and allow the display module to display images by using electronic elements (e.g., active device or pixel array) inside the display panel. These components may be assembled together through an optical clear adhesive (OCA) layer. For example, the cover plate may be adhered to the optical film and the display panel through the optical clear adhesive. However, when a drop test is performed to the display module after the display module is assembled, a stress accumulating at a corner of the optical film tends to peel the optical film off from the optical clear adhesive layer and thus damages the display module. The reliability of the display module is thus influenced.

### SUMMARY OF THE INVENTION

The application provides a display module having a preferable reliability.

A display module of the application includes a display panel, an optical film, a cover plate and an optical clear adhesive layer. The display panel has a display surface. The optical film is disposed on the display surface, wherein the optical film has a first surface back to the display panel, and the first surface has a plurality of edges and a plurality of corners formed by any adjacent two of the edges crossing each other. The cover plate is disposed on the first surface of the optical film and covers the first surface. The optical clear adhesive layer is disposed between the cover plate and the optical film and connected with the cover plate and the optical film, wherein the optical clear adhesive layer covers the edges of the first surface and exposes the corners and a part of regions adjacent to the corners.

Based on the above, in the display module of the application, the first surface of the optical film back to the display panel has the edges and the corners formed by any adjacent two of the edges crossing each other, and the optical clear adhesive layer connected with the cover plate and the optical film covers the edges of the first surface and exposes the corners and a part of the regions adjacent to the corners. In this way, the optical clear adhesive layer is not adhered to the corners of the optical film, so as to prevent the optical film and the optical clear adhesive layer from being peeled off from each other due to the stress generated at the corners when the mechanical test is performed to the display module. Accordingly, the display module of the invention has a preferable reliability.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view illustrating a display panel according to an embodiment of the invention.

FIG. 2 is a schematic cross-sectional view illustrating the display panel shown in FIG. 1 along an I-I′ line.

FIGS. 3 and 4 are partial schematic views illustrating display panels according to other embodiments of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

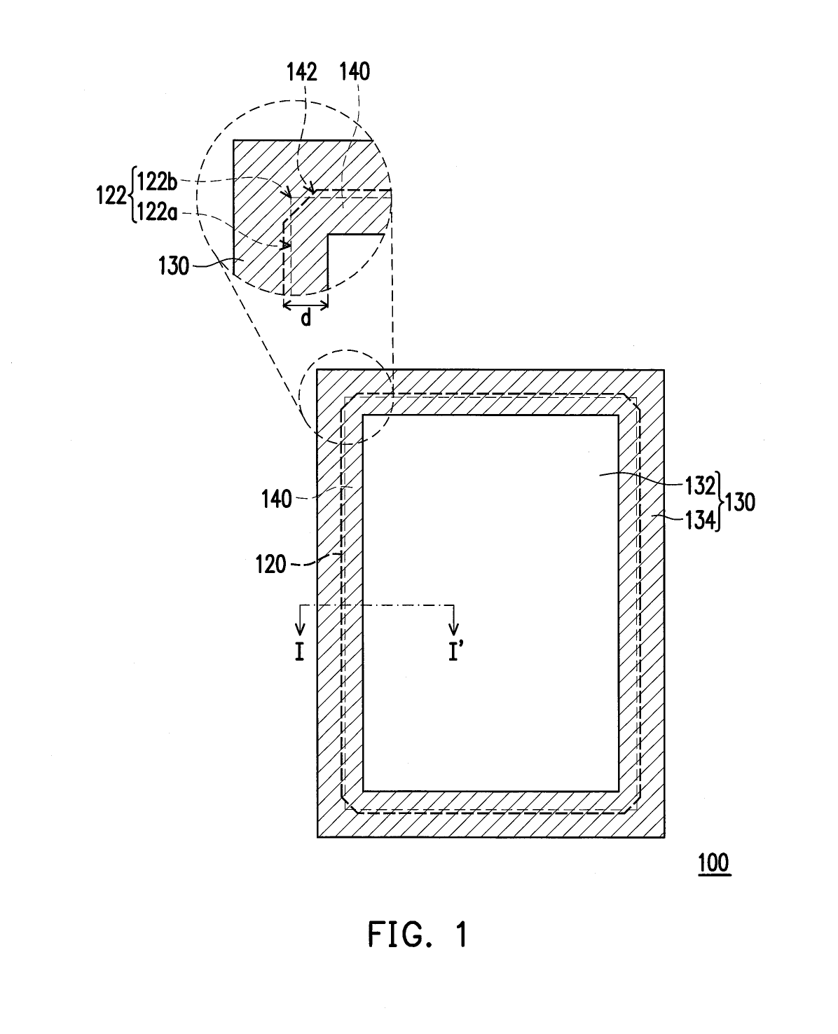

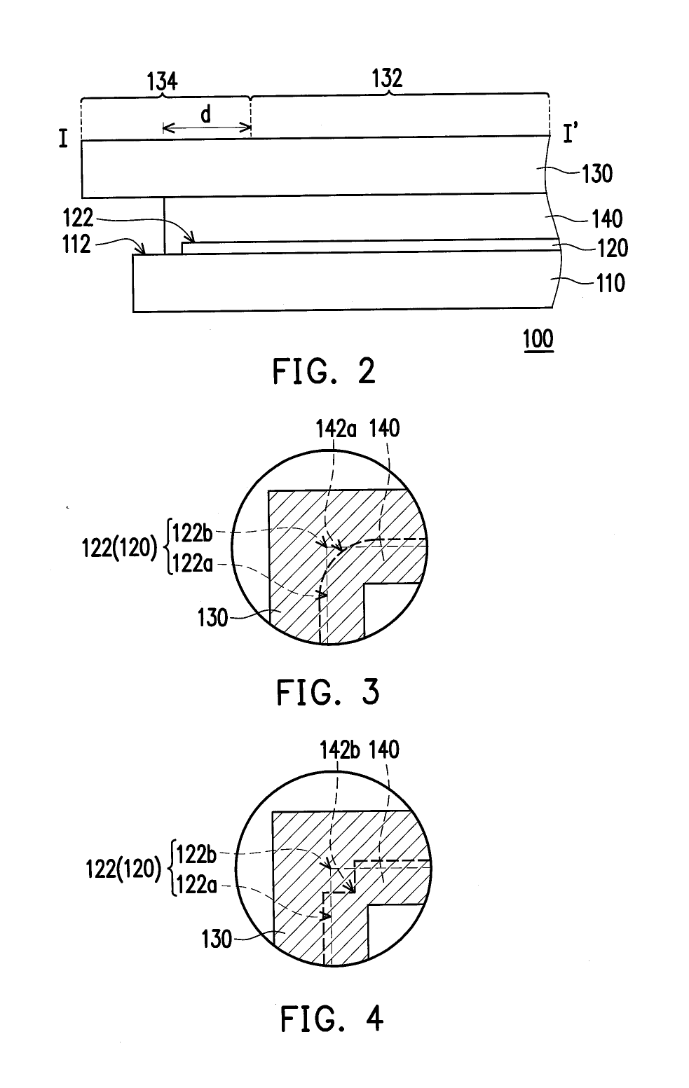

FIG. 1 is a schematic top view illustrating a display panel according to an embodiment of the invention. FIG. 2 is a schematic cross-sectional view illustrating the display panel shown in FIG. 1 along an I-I′ line. Referring to FIGS. 1 and 2, in this embodiment, a display module 100 includes a display panel 110 (shown in FIG. 2), an optical film 120, a cover plate 130, and an optical clear adhesive layer 140. In addition, the display panel 110 is omitted from FIG. 1, and FIGS. 1 and 2 also omit other components suitable for the display panel (e.g., an assembling frame), so as to more clearly illustrate relative relations between the optical film 120, the cover plate 130, and the optical clear adhesive layer 140 in the drawings. In this embodiment, the display panel 110 is a liquid crystal display (LCD) panel, an organic light emitting diode (OLED) display panel, or other suitable display panels, for example, and includes a thin film transistor (TFT) array substrate, a color filter (CF) substrate, or other components suitable for the display panel. The application does not intend to limit a type and a configuration of the display panel. Accordingly, the display panel 110 has a display surface 112, so as to be suitable to display an image.

Moreover, in this embodiment, the optical film 120 is disposed on the display surface 112. The optical film 120 is a polarizer, for example. However, in other embodiments, the optical film 120 may also be other suitable optical films, and the application does not intend to limit a type of the optical film 120. The optical film 120 has a first surface 122 back to the display panel 110, and the cover plate 130 is disposed on the first surface 122 of the optical film 120 and covers the first surface 122. The optical clear adhesive layer 140 is disposed between the cover plate 130 and the optical film 120, and is connected with the cover plate 130 and the optical film 120. The cover plate 130 is a glass cover plate, a plastic substrate, a sapphire substrate, or other suitable cover plates, for example, and is usually disposed at an outermost layer of the display module 100 as protection. However, the application does not intend to limit a type of the cover plate 130 and whether another component is disposed at an external side of the cover plate 130. The optical clear adhesive layer 140 is configured to adhere the cover plate 130 to the optical film 120, and preferably extends to an external side of the optical film 120 to adhere to the cover plate 130 and the display panel 110, as shown in FIG. 2. In addition, a touch unit (not shown) may be further disposed between the cover plate 130 and the display panel 110 in the display module 100 based on the needs. Based on a type of the touch unit, the touch unit may be manufactured between the cover plate 130 and the optical clear adhesive layer 140 or between the optical clear adhesive layer 140 and the display panel 110, and may also be manufactured on an additional base material and then disposed between the cover plate 130 and the display panel 110 by using an additional adhesive layer. The application does not intend to limit a position of the touch unit and whether the touch unit is disposed or not.

In this embodiment, the optical clear adhesive layer 140 may not only be connect with the cover plate 130 and the optical film 120, but also have a special design in shape to improve a reliability of the display module 100.

Specifically, taking this embodiment as an example, the first surface 122 of the optical film 120 of this embodiment is rectangular. Besides, the first surface 122 has four edges 122a and four corners 122b formed by any adjacent two of the edges 122a crossing each other. Moreover, the corners 122b of the first surface 122 include a plurality of right angles. However, a shape of the optical film 120 may be adjusted based on the needs, and the application is not limited thereto. During assembling of the display module 100, the optical film 140 covers the first surface 122 and extends to a side edge of the optical film 120 to be connected with the cover plate 130 and the display panel 110, as shown in FIG. 2. In this way, the optical clear adhesive layer 140 also covers the edges 122a of the first surface 122 of the optical film 120. However, the optical clear adhesive layer 140 in this embodiment exposes the corners 122b and a part of regions adjacent to the corners 122b. In other words, the optical clear adhesive layer 140 does not cover the corners 122b and a part of the regions adjacent to the corners 122b, as shown in FIG. 1.

More specifically, in this embodiment, the optical clear adhesive layer 140 has a plurality of corner portions 142, and the corner portions 142 correspondingly expose the corners 122b. For example, the optical clear adhesive layer 140 of this embodiment is substantially rectangular and has four corner portions 142 respectively corresponding to the four corners 122b of the first surface 122. Also, in this embodiment, edges of normal projections of the corner portions 142 on the cover plate 130 are linear. In other words, the corner portions 142 of this embodiment may be obtained to expose the corners 122b by cutting off the right angles corresponding to the corners 122b from the optical clear adhesive layer 140 substantially rectangular. In this way, when a mechanical test, such as a drop test or a roller test, is performed to the display module 100 after being assembled, and a stress accumulates at the corners 122b, since the optical clear adhesive layer 140 does not cover the corners 122b, the optical film 120 and the optical clear adhesive layer 140 are not peeled off from each other because of the stress at the corners 122b. Accordingly, a rate that the display module 100 passes the mechanical test is improved, and the display module 100 thus has a higher reliability.

However, the application does not intend to limit a shape of the corner portion 142. For example, referring to FIG. 3, FIG. 3 is a partial schematic view illustrating a display panel according to another embodiment of the invention. In this embodiment, edges of normal projections of corner portions 142a on the cover plate 130 are curved, making the corners 122b of the first surface 122 and a part of the regions adjacent to the corners 122b exposed. Similarly, referring to FIG. 4, FIG. 4 is a partial schematic view illustrating a display panel according to another embodiment of the invention. In this embodiment, edges of normal projections of corner portions 142b on the cover plate 130 are right angles recessed inwardly toward the optical clear adhesive layer 140, making the corners 122b and a part of the regions adjacent to the corners 122b exposed. Thus, it can be known that the application does not intend to limit shapes of the corner portions 142, 142a, and 142b, and the shape may be designed based on the needs, so as to correspondingly expose the corners 122b.

Besides, in this embodiment, there are other designs of the optical clear adhesive layer 140 to improve the reliability of the display module.

Specifically, in this embodiment, the cover plate 130 has a transparent region 132 and a shielding region 134 located at an external side of the transparent region 132. Preferably, the shielding region 134 of this embodiment may be disposed to surround the external side of the transparent region 132. However, the invention is not limited thereto. Here, to clearly distinguish the shielding region 134 from the transparent region 132 in FIGS. 1, 3, and 4, the shielding region 134 is indicated with oblique lines in FIGS. 1, 3, and 4. The shielding region 134 may be formed by disposing a colored ink layer (not shown) having a high light shielding property or other shielding materials around a periphery of the cover plate 130. However, the application does not intend to limit how the shielding region 134 is formed. The transparent region 132 corresponds to the display surface 112, such that the image generated by the display panel 110 may be transmitted out of the display module 100 from the display surface 112 through the optical film 120, the optical clear adhesive layer 140, and the transparent region 132 of the cover plate 130. On the contrary, the shielding region 134 may be used to shield peripheral wiring (not shown) or peripheral components (not shown) inside the display module 100. During assembling of the display module 100, the optical clear adhesive layer 140 is disposed in the transparent region 132 and extends to the shielding region 134. In other words, a normal projection of the optical clear adhesive layer 140 with respect to the cover plate 130 corresponds to the transparent region 132 and extends to the shielding region 134. Preferably, a distance d that the optical clear adhesive layer 140 extends to the shielding region 134 may be 0.6 mm or more. However, the application is not limited thereto.

In this way, when an autoclave process is performed during assembling of the display module 100, since the optical clear adhesive layer 140 extends from the transparent region 132 of the cover plate 130 to the shielding region 134, bubbles that are generated due to an overly large pressure may be prevented from moving to a region of the optical clear adhesive layer 140 near the transparent region 132. In other words, even if bubbles are generated between the optical clear adhesive layer 140 and the cover plate 130 due to an overly large pressure in the autoclave process performed to the display module 100, the bubbles merely stay at a periphery of the optical clear adhesive layer 140 and correspond to the shielding region 134. Namely, a region that may generate bubbles in the periphery of the optical clear adhesive layer 140 of this embodiment is covered by the shielding layer 134. Accordingly, in the display module 100 of this embodiment, a visual effect is not influenced by the bubbles generated during assembling of the display module 100. Thus, the display module 100 has a preferable reliability.

In view of the foregoing, in the display module of the application, the first surface of the optical film back to the display panel has the edges and the corners formed by any adjacent two of the edges crossing each other, and the optical clear adhesive layer connected with the cover plate and the optical film covers the edges of the first surface and exposes the corners and a part of the regions adjacent to the corners. In this way, the optical clear adhesive layer is not adhered to the corners of the optical film, so as to prevent the optical film and the optical clear adhesive layer from being peeled off from each other due to the stress generated at the corners when the mechanical test is performed to the display module. Moreover, since the optical clear adhesive layer extends from the transparent region of the cover plate to the shielding region, bubbles may be prevented from being generated at regions of the optical clear adhesive layer adjacent to the transparent region during assembling of the display module and influencing the visual effect of the display module. Accordingly, the display module of the application has a preferable reliability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display module, comprising:
a display panel, having a display surface;
an optical film, disposed on the display surface, wherein the optical film has a first surface back to the display panel, and the first surface has a plurality of edges and a plurality of corners formed by any adjacent two of the edges crossing each other;
a cover plate, disposed on the first surface of the optical film and covering the first surface; and
an optical clear adhesive layer, disposed between the cover plate and the optical film and connected with, the cover plate and the optical film, wherein the optical clear adhesive layer covers the edges of the first surface and exposes the corners and a part of regions adjacent to the corners.

2. The display module as claimed in claim 1, wherein the cover plate has a transparent region and a shielding region located at an external side of the transparent region, the transparent region corresponds to the display surface, and the optical clear adhesive layer is disposed in the transparent region and extends to the shielding region.

3. The display module as claimed in claim 2, wherein a distance that the optical clear adhesive layer extends to the shielding region is 0.6 mm or more.

4. The display module as claimed in claim 1, wherein the corners of the first surface comprise a plurality of right angles.

5. The display module as claimed in claim 1, the optical clear adhesive layer has a plurality of corner portions, and the corner portions correspondingly expose the corners.

6. The display module as claimed in claim 5, wherein edges of normal projections of the corner portions on the cover plate are curved.

7. The display module as claimed in claim 5, wherein edges of normal projections of the corner portions on the cover plate are linear.

8. The display module as claimed in claim 5, wherein edges of normal projections of the corner portions on the cover plate are right angles recessed inwardly toward the optical clear adhesive layer.

9. The display module as claimed in claim 1, further comprising:
a touch unit, disposed between the cover plate and the display panel.

10. The display module as claimed in claim 1, wherein the optical film comprises a polarizer.
